(19) United States
(12) Patent Application Publication
(10) Pub. No.: US 2026/0062291 A1
(43) Pub. Date: Mar. 5, 2026

(54) MASS PRODUCTION METHOD FOR HIGH-PURITY LITHIUM SULFIDE USING INERT GAS BUBBLING

(71) Applicant: LAKE TECHNOLOGY., LTD, Sejong-si (KR)

(72) Inventors: Sang Yun LEE, Sejong-si (KR); Seong Hoon JEONG, Cheonan-si Chungcheongnam-do (KR); Se Hyun KIM, Sejong-si (KR); Jeong Hyeon PARK, Daejeon (KR); Sung Yoon BAEK, Sejong-si (KR); Taek Seung YANG, Icheon-si Gyeonggi-do (KR); Yik Haeng CHO, Daejeon (KR); Chang Ho SONG, Chungcheongbuk-do (KR); Jin Dong KIM, Sejong-si (KR)

(73) Assignee: LAKE TECHNOLOGY., LTD, Sejong-si (KR)

(21) Appl. No.: 19/378,927

(22) Filed: Nov. 4, 2025

Related U.S. Application Data
(63) Continuation of application No. PCT/KR2025/008128, filed on Jun. 13, 2025.

(30) Foreign Application Priority Data
Aug. 8, 2024 (KR) 10-2024-0106323

(51) Int. Cl. C01B 17/22; H01M 10/052; H01M 10/0562

(52) U.S. Cl. CPC C01B 17/22; H01M 10/052; H01M 10/0562; C01P 2002/72; C01P 2004/51; C01P 2004/61; C01P 2006/12; C01P 2006/40; C01P 2006/80; H01M 2300/0068

(57) ABSTRACT

The present invention relates to a method of producing lithium sulfide, and according to the present invention, when producing lithium sulfide by a reaction between a lithium raw material and hydrogen sulfide, the reaction is performed under relatively mild conditions compared to the conventional technology, so frequent repairs or replacements due to corrosion and breakdown of reactors and piping are not required, thereby improving the economic efficiency of the process. In addition, since unreacted hydrogen sulfide and a solvent from which moisture has been removed are reused, process costs are reduced so that economic feasibility in mass production is ensured. Furthermore, moisture and water vapor generated in a lithium sulfide production reaction are effectively removed to prevent a reverse reaction into lithium hydroxide and promote a forward reaction so that high-quality lithium sulfide can be produced with high purity and high yield.

### CROSS-REFERENCE TO RELATED APPLICATIONS

This application is a continuation of International Application No. PCT/KR2025/008128 filed on Jun. 13, 2025, which claims priority to Korean Patent Application No. 10-2024-0106323 filed on Aug. 8, 2024, the entire contents of which are herein incorporated by reference.

### TECHNICAL FIELD

The present invention relates to a method of producing lithium sulfide.

### BACKGROUND ART

Lithium secondary batteries have high energy density and long lifetimes, and thus they are widely used in electronic devices such as home appliances, laptop computers, and smartphones. Recently, their utilization has been greatly increasing, as they are also mounted on electric vehicles (EVs) and hybrid electric vehicles (HEVs).

Lithium-ion secondary batteries that are mainly used today have been widely used as the main power source for mobile phones, laptop computers, and PCs since mass production began in 1991, thanks to their high energy density and output voltage. However, an organic electrolyte that is included to facilitate the migration of lithium ions includes a risk of explosion under overheating and overcharging conditions. Furthermore, it may easily ignite in the presence of an ignition source, and side reactions within the battery may cause gas generation, deteriorating battery performance and stability.

To overcome these shortcomings of lithium-ion secondary batteries, active research and development is underway on all-solid-state lithium secondary batteries. All-solid-state lithium secondary batteries not only reduce the risk of explosion by employing a solid electrolyte instead of a volatile electrolyte, but also offer the advantage of dramatically improving battery energy density by allowing the use of lithium metal or a lithium alloy as a negative electrode material.

Today, among the solid electrolyte candidates that may be included in all-solid-state batteries, sulfide-based solid electrolytes, known for their high ductility and ionic conductivity, are evaluated as suitable for manufacturing high-capacity, large-scale secondary batteries, and lithium sulfide (Li₂S) is evaluated as a key material in the manufacturing process of such sulfide-based solid electrolytes. Various methods of synthesizing lithium sulfide are known, but the most common method is known to be allowing lithium metal, such as lithium hydroxide (LiOH) or lithium carbonate (Li₂CO₃), to react with hydrogen sulfide (H₂S).

Meanwhile, conventional technologies have problems in that when lithium metal, such as lithium hydroxide, is allowed to react with hydrogen sulfide, the supplied hydrogen sulfide may be discharged without fully reacting, or the reaction rate of hydrogen sulfide may be low, hindering the economic feasibility of lithium sulfide mass production.

In addition, reacting lithium metal, such as lithium hydroxide, with hydrogen sulfide inevitably generates water vapor, which not only interferes with the contact between lithium metal and hydrogen sulfide, reducing the yield of lithium sulfide, but also reacts with lithium sulfide to accelerate a reverse reaction of lithium sulfide into lithium hydroxide, thereby reducing the purity of the resulting lithium sulfide. Furthermore, moisture and water vapor may cause agglomeration between the produced lithium sulfide particles, deteriorating product quality.

Accordingly, the present inventors have studied a method for economically producing lithium sulfide having a size of several to several tens of microns by establishing a high-purity, high-yield process in which a lithium compound and hydrogen sulfide are allowed to react under relatively mild conditions, moisture is removed through gas bubbling to promote a forward reaction, and moisture is removed from a solvent and unreacted hydrogen sulfide, which are then reused in the production of lithium sulfide, thereby completing the present invention.

### DISCLOSURE

### Technical Problem

The present invention aims to solve the above-described problems and provides a method of producing lithium sulfide, which is capable of economically mass-producing high-purity lithium sulfide at high yield, by designing reaction conditions and an apparatus suitable for mass-producing high-purity lithium sulfide at high yield through a reaction between a lithium raw material and hydrogen sulfide (H₂S), removing moisture through inert gas bubbling supply to promote a forward reaction, and further removing moisture from unreacted hydrogen sulfide and a solvent and reusing it.

### Technical Solution

The present invention provides a method of producing lithium sulfide, including: a) a step of supplying a lithium raw material into a reaction chamber provided with a solvent; b) a step of supplying hydrogen sulfide (H₂S) into the reaction chamber to initiate a lithium sulfide (Li₂S) production reaction, the step including, when the reaction reaches chemical equilibrium, supplying an inert gas by bubbling and then re-supplying the hydrogen sulfide into the reaction chamber; and c) a step of transferring a product obtained in Step b) to a lithium sulfide recovery portion to obtain lithium sulfide.

For example, the method may further include, after Step a) and before Step b), a step of removing moisture within the reaction chamber by heating for one to five hours while maintaining the reaction chamber at a temperature ranging from 80 to 200° C.

For example, the solvent of Step a) may be an aprotic solvent selected from cycloheptane, cyclooctane, methylcyclohexane, dimethylcyclohexane, trimethylcyclohexane, ethylcyclohexane, diethylcyclohexane, propylcyclohexane, isopropylcyclohexane, dipropylcyclohexane, butylcyclohexane, tert-butylcyclohexane, methylcycloheptane, and methylcyclooctane; octane, isooctane, nonane, isononane, decane, isodecane, undecane, dodecane, hexadecane, and octadecane; toluene, o-, m-, and p-xylene, 1,3,5-trimethylbenzene (mesitylene), 1,2,4- and 1,2,3-trimethylbenzene, ethylbenzene, propylbenzene, isopropylbenzene, butylbenzene, isobutylbenzene, tert-butylbenzene, and cyclohexylbenzene; naphthalene, decahydronaphthalene (decalin), 1- and 2-methylnaphthalene, 1- and 2-ethylnaphthalene; tetrahydrofuran, 2-methyltetrahydrofuran, 2,5-dimethyltetrahydrofuran, 1,4-dioxane, dibutyl ether, isoamyl ether, dihexyl ether, 1,2-dimethoxyethane; and a combination thereof.

For example, the solvent of Step a) may be provided in a volume ranging from 50% to 80% based on a total volume of the reaction chamber.

For example, the lithium raw material of Step a) may be one selected from lithium hydroxide (LiOH), lithium hydroxide monohydrate (LiOH·H₂O), lithium carbonate (Li₂CO₃), and a combination thereof.

For example, the lithium sulfide production reaction in Step b) is as shown in Chemical Equation 1 below and may be performed for 10 to 60 hours at a temperature ranging from 120 to 300° C. and a pressure ranging from 0.01 to 5.0 bar in the reaction chamber.

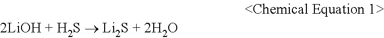

For example, in Step b), the inert gas may be one selected from nitrogen (N₂), argon (Ar), helium (He), and a combination thereof.

For example, in Step b), a solvent replenished during the reaction may be one selected from a newly supplied solvent, a solvent recovered between processes, and a combination thereof.

For example, in Step c), a gas flow may be generated in the lithium sulfide recovery portion to remove the solvent and impurities and dry the lithium sulfide.

For example, the percentage of the lithium raw material that is consumed by the reaction through Steps a) to c) may be 97.99% or more.

In addition, the present invention provides lithium sulfide produced according to the above-described method, having an average particle size (D50) in a range of 1 to 200 μm and a Brunauer-Emmett-Teller (BET) specific surface area in a range of 1 to 14 m²/g.

For example, the lithium sulfide may have a carbon content of less than 0.5% by weight and a purity of 97.99% or more.

In addition, the present invention provides a lithium all-solid-state secondary battery including: a positive electrode; a negative electrode facing the positive electrode; and a sulfide-based solid electrolyte interposed between the positive electrode and the negative electrode and made of the above-described lithium sulfide.

For example, the lithium solid-state secondary battery may be applied to one or more products selected from electric vehicles (EVs), hybrid electric vehicles (HEVs), energy storage systems (ESSs), urban air mobility (UAM), mobile devices, laptops, electronic devices, tablets, drones, robots, and home appliances.

### Advantageous Effects

According to the present invention, when producing lithium sulfide by a reaction between a lithium raw material and hydrogen sulfide, the reaction is performed under relatively mild conditions compared to the conventional technology, so frequent repairs or replacements due to corrosion and breakdown of reactors and piping are not required, thereby improving the economic efficiency of the process. In addition, since unreacted hydrogen sulfide and a solvent from which moisture has been removed are reused, process costs are reduced so that economic feasibility in mass production is ensured.

Furthermore, moisture and water vapor generated in a lithium sulfide production reaction are effectively removed to prevent a reverse reaction into lithium hydroxide and promote a forward reaction so that high-quality lithium sulfide can be produced with high purity and high yield.

### DESCRIPTION OF DRAWINGS

FIG. 1 is a schematic diagram illustrating each step of a method of producing lithium sulfide according to one embodiment of the present invention.

FIGS. 2A, 2B, 3A, 3B, 4A, 4B, 5A and 5B show the results of an X-ray diffraction (XRD) analysis and a particle size analysis performed to confirm the presence of lithium sulfide prepared according to examples and a comparative example of the present invention.

FIG. 6 is a schematic diagram illustrating an example of an apparatus for producing lithium sulfide applicable to a method of producing lithium sulfide according to one embodiment of the present invention

### DETAILED DESCRIPTION

Hereinafter, embodiments of the present invention will be described in detail with reference to the accompanying drawings. When designating components in each drawing, it should be noted that, where possible, identical components are given the same reference numerals, even when they appear in different drawings. Furthermore, when describing embodiments of the present invention, detailed descriptions of known components or functions will be omitted when they are deemed to hinder understanding of the embodiments of the present invention.

Hereinafter, a method of producing lithium sulfide, lithium sulfide produced thereby, and an apparatus for producing lithium sulfide according to the present invention will be described in more detail.

### Method of Producing Lithium Sulfide

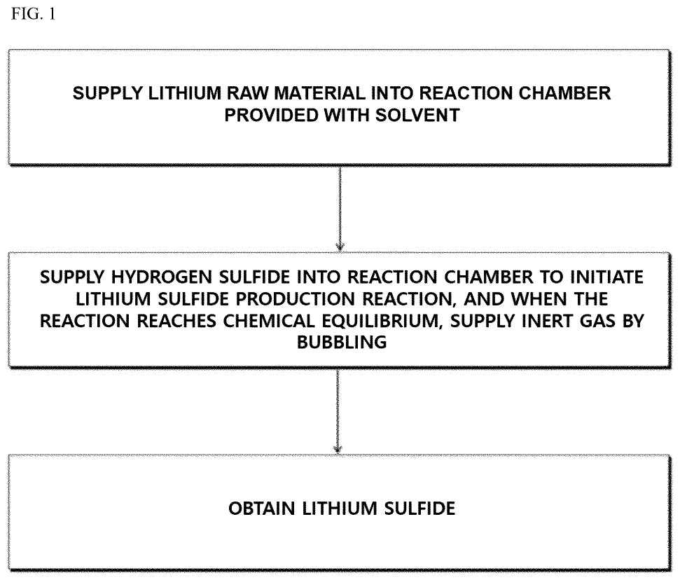

A method of producing lithium sulfide according to one embodiment of the present invention includes: a) a step of supplying a lithium raw material into a reaction chamber provided with a solvent; b) a step of supplying hydrogen sulfide (H₂S) into the reaction chamber to initiate a lithium sulfide (Li₂S) production reaction, the step including, when the reaction reaches chemical equilibrium, supplying an inert gas by bubbling and then re-supplying the hydrogen sulfide into the reaction chamber; and c) a step of transferring a product obtained in Step b) to a lithium sulfide recovery portion to obtain lithium sulfide (see FIG. 1).

First, a lithium raw material is supplied into a reaction chamber provided with a solvent (Step a)).

The reaction chamber is a chamber having a predetermined reaction space in which a lithium sulfide production reaction is performed, and a lithium raw material and hydrogen sulfide react in the reaction space to synthesize lithium sulfide. The detailed components of the reaction chamber will be described later.

The solvent provided in the reaction chamber may be a solvent used in a wet reaction, and it may be an aprotic solvent, specifically, one selected from cycloheptane, cyclooctane, methylcyclohexane, dimethylcyclohexane, trimethylcyclohexane, ethylcyclohexane, diethylcyclohexane, propylcyclohexane, isopropylcyclohexane, dipropylcyclohexane, butylcyclohexane, tert-butylcyclohexane, methylcycloheptane, and methylcyclooctane; octane, isooctane, nonane, isononane, decane, isodecane, undecane, dodecane, hexadecane, and octadecane; toluene, o-, m-, and p-xylene, 1,3,5-trimethylbenzene (mesitylene), 1,2,4- and 1,2,3-trimethylbenzene, ethylbenzene, propylbenzene, isopropylbenzene, butylbenzene, isobutylbenzene, tert-butylbenzene, and cyclohexylbenzene; naphthalene, decahydronaphthalene (decalin), 1- and 2-methylnaphthalene, 1- and 2-ethylnaphthalene; tetrahydrofuran, 2-methyltetrahydrofuran, 2,5-dimethyltetrahydrofuran, 1,4-dioxane, dibutyl ether, isoamyl ether, dihexyl ether, 1,2-dimethoxyethane; and a combination thereof.

The solvent in the above-described step may be provided in a volume ranging from 50% to 80% based on a total volume of the reaction chamber. When the solvent is included in an amount less than the above-described volume range, there may be a problem in which lithium sulfide particles synthesized during the lithium sulfide production reaction splash and stick to walls of the reaction space or grow and become fixed. On the other hand, when the amount of the solvent exceeds the above-described volume range, the space for an inert gas or hydrogen sulfide gas (H₂S) supplied to satisfy pressure conditions required during the lithium sulfide production reaction is reduced, making it difficult to control the pressure conditions, and the solvent may also flow back to another component of the apparatus.

The lithium raw material of the present invention is a reactant that reacts with hydrogen sulfide gas (H₂S) supplied and produces lithium sulfide in a step described later, and it may be one selected from lithium hydroxide (LiOH), lithium hydroxide monohydrate (LiOH·H₂O), lithium carbonate (Li₂CO₃), and a combination thereof. For example, the lithium raw material may be lithium hydroxide monohydrate (LiOH·H₂O), and in this case, the raw material is easy to obtain and the cost is low, so it may be more suitable for ensuring economic feasibility and mass production.

The method may further include, after the above-described Step a) and before Step b) that will be described later, a step of removing moisture within the reaction chamber.

Specifically, the step may be performed to prevent a reverse reaction of the lithium sulfide (Li₂S) production reaction in Step b), which will be described later, from being accelerated, by removing moisture within the reaction chamber, thereby preventing the reduction in a conversion rate into lithium sulfide. For example, the step may be performed by heating with a heating portion, which will be described later, for one to five hours while maintaining the reaction space within the reaction chamber at a temperature ranging from 80 to 200° C., specifically, from 90 to 150° C.

In the above-described step, stirring may be performed to selectively remove moisture within the reaction chamber while suppressing solvent vaporization as much as possible. For example, the stirring may be performed at a stirring speed ranging from 300 to 800 rpm. In addition, in the above-described step, an inert gas may be supplied by bubbling to ensure smooth moisture removal.

Next, the method includes a step of supplying hydrogen sulfide (H₂S) into the reaction chamber to initiate a lithium sulfide (Li₂S) production reaction, and the step includes, when the reaction reaches chemical equilibrium, supplying an inert gas by bubbling and then re-supplying the hydrogen sulfide into the reaction chamber (Step b)).

The lithium raw material supplied in Step a) may be synthesized into lithium sulfide (Li₂S) through a wet reaction with hydrogen sulfide (H₂S) gas supplied into the reaction chamber in Step b) under solvent conditions. When the lithium raw material is lithium hydroxide, a specific chemical reaction may be as shown in <Chemical Equation 1> below:

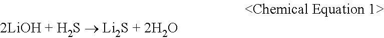

The lithium sulfide production reaction according to one embodiment of the present invention may be performed at a reaction chamber temperature ranging from 120 to 300° C., specifically from 120 to 250° C., and more specifically from 120 to 200° C., and the pressure may be performed at a pressure ranging from 0.01 to 5.0 bar, specifically from 1.5 to 3.0 bar, and more specifically from 2 to 2.5 bar. In addition, the reaction may be performed for 10 to 60 hours, and stirring may be performed during the reaction to promote the reaction.

In addition, according to one embodiment of the present invention, the inert gas bubbling and hydrogen sulfide re-supply process of Step b) may be repeated one or more times. Specifically, when hydrogen sulfide is supplied into the reaction chamber, a lithium sulfide production reaction is initiated, and a point is reached where the rates of a forward reaction and a reverse reaction become equal and thus chemical equilibrium is achieved during the reaction. At this point, when the reaction is terminated as is, it may be difficult to obtain a desired level of lithium sulfide purity, and therefore, inert gas bubbling is performed according to the present invention. The inert gas bubbling supply discharges moisture remaining in the solvent and water vapor present in the reaction chamber to the outside of the reaction chamber, thereby breaking the chemical equilibrium, allowing the forward reaction to resume. At this time, when hydrogen sulfide is supplied into the reaction chamber again, the lithium sulfide production reaction is initiated again. Therefore, when the inert gas bubbling and hydrogen sulfide re-supply process of Step b) are repeated, the conversion rate of the lithium raw material into lithium sulfide can be maximized.

Meanwhile, the inert gas may be supplied to one end or the bottom of the reaction chamber, and the bubbling supply of the inert gas may be performed for one to five hours per time, specifically one to three hours, but this may vary depending on various factors such as the amount of the lithium raw material and the size of the reaction chamber. The inert gas according to one embodiment of the present invention may be one selected from nitrogen (N₂), argon (Ar), helium (He), and a combination thereof, and for example, it may be nitrogen (N₂). When nitrogen (N₂) is used as an inert gas, it has the advantages of being inexpensive and easy to handle, without significantly affecting the lithium sulfide production reaction.

In this step, the hydrogen sulfide (H₂S) supplied or re-supplied into the reaction chamber may be one selected from newly supplied hydrogen sulfide, hydrogen sulfide recovered between processes, and a combination thereof. Meanwhile, the unreacted hydrogen sulfide recovered between processes may be unreacted in Step b), discharged outside the reaction chamber, and then re-supplied to the reaction chamber through a circulation process, and the circulation of the unreacted hydrogen sulfide may mean passing through a condensation portion, a hydrogen sulfide re-supply portion, and the like, which will be described later.

In addition, in this step, a part of the solvent may be vaporized and discharged outside the reaction chamber. Therefore, the solvent may be replenished during the reaction, and in this case, the solvent may be one selected from a newly supplied solvent, a solvent recovered between processes, and a combination thereof. Meanwhile, the solvent recovered between processes may be vaporized in Step b), discharged outside the reaction chamber, and then re-supplied to the reaction chamber through a circulation process. The circulation of the solvent may mean passing through a condensation portion, a solvent re-supply portion, and the like, which will be described later.

Next, a product obtained in Step b) is transferred to a lithium sulfide recovery portion to obtain lithium sulfide (Step c)).

The step may include a process of generating a gas flow to remove the solvent and impurities and dry the lithium sulfide.

As described below, the lithium sulfide recovery portion may include a filter reactor including at least one selected from a blower, an impeller, and a filter member (F), or a vacuum filter capable of performing vacuum drying.

Specifically, the process of removing the solvent and impurities may be performed using a horizontal or vertical gas flow generated from a blower installed in a filter reactor, and the lithium sulfide may be dried simultaneously during this process. The gas flow may be a flow of an inert gas selected from nitrogen (N₂), argon (Ar), helium (He), or a combination thereof. The gas flow may have a rate in a range of 1 to 10 kph. During this process, the lithium sulfide recovery portion may have a temperature ranging from 80 to 150° C., specifically from 80 to 130° C.

Meanwhile, the percentage of the lithium raw material that is consumed by the reaction in Steps a) through c) of the present invention may be 97.99% or greater, specifically 98.99% or greater, and more specifically 99.99% or greater.

According to the method of producing lithium sulfide of the present invention, when producing lithium sulfide by a reaction between a lithium raw material and hydrogen sulfide, the reaction is performed under relatively mild conditions compared to the conventional technology, so frequent repairs or replacements due to corrosion and breakdown of reactors and piping are not required, thereby improving the economic efficiency of the process. In addition, since unreacted hydrogen sulfide and a solvent from which moisture has been removed are reused, process costs are reduced so that economic feasibility in mass production is ensured.

Furthermore, moisture and water vapor generated in the lithium sulfide production reaction are effectively removed to prevent a reverse reaction into lithium hydroxide and promote a forward reaction so that high-quality lithium sulfide can be produced with high purity and high yield.

### Lithium Sulfide

Lithium sulfide (Li₂S) produced according to one embodiment of the present invention has an average particle size (D50) ranging from 1 to 200 μm, specifically from 1 to 120 μm. Furthermore, the lithium sulfide (Li₂S) may have a Brunauer-Emmett-Teller (BET) specific surface area ranging from 1 to 14 m²/g.

In addition, the lithium sulfide produced according to one embodiment of the present invention has a carbon content of less than 0.5% by weight, specifically less than 0.3% by weight. The carbon content may refer to the total carbon content in the finally obtained lithium sulfide, measured using a non-dispersive infrared (ND-IR) analysis method. Meanwhile, the finally obtained lithium sulfide according to the present invention may have a purity of 97.99% or more, specifically 98.99% or more, and more specifically 99.99% or more, and the purity may be measured by an XRD semi-quantitative analysis.

Furthermore, according to an additional embodiment of the present invention, the lithium sulfide can be utilized as a key material in the manufacture of a sulfide-based solid electrolyte such as argyrodite-based electrolytes or Li—P—S (LPS)-based electrolytes.

Specifically, a lithium all-solid-state secondary battery according to one embodiment of the present invention may include: a positive electrode; a negative electrode facing the positive electrode; and a sulfide-based solid electrolyte interposed between the positive electrode and the negative electrode and made of the above-described lithium sulfide. In addition, the lithium solid-state secondary battery may be applied to one or more products/technical fields selected from electric vehicles (EVs), hybrid electric vehicles (HEVs), energy storage systems (ESSs), urban air mobility (UAM), mobile devices, laptops, electronic devices, tablets, drones, robots, and home appliances.

### Apparatus for Producing Lithium Sulfide

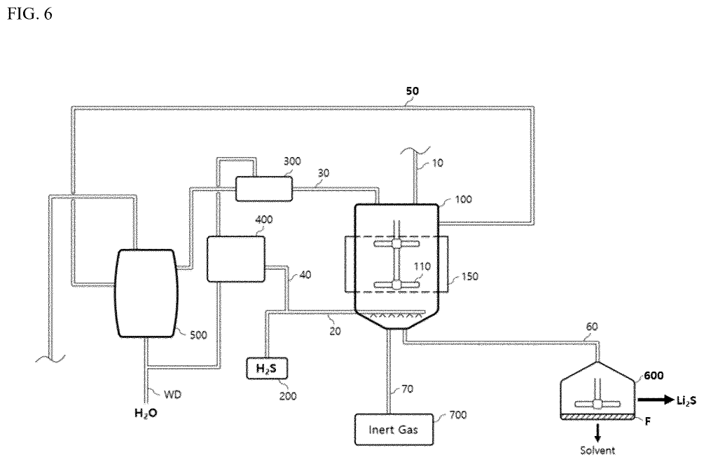

FIG. 6 is a schematic diagram illustrating an example of an apparatus for producing lithium sulfide applicable to the method of producing lithium sulfide according to one embodiment of the present invention. Hereinafter, the production apparatus will be described with reference to FIG. 6.

An apparatus for producing lithium sulfide according to one embodiment of the present invention includes a reaction chamber 100, a heating portion 150, a hydrogen sulfide supply portion 200, a condensation portion 300, a hydrogen sulfide re-supply portion 400, a solvent re-supply portion 500, and a lithium sulfide recovery portion 600. Meanwhile, although not shown, a separately provided supply means, such as a circulation pump, may be used as a means for promoting material movement between components within the production apparatus.

The reaction chamber 100 is a chamber having a predetermined reaction space where a lithium sulfide production reaction is performed, and a lithium raw material and hydrogen sulfide react in the reaction space to synthesize lithium sulfide (Li₂S). The shape of the reaction chamber is not particularly limited, as long as it has the predetermined reaction space. The reaction space of the reaction chamber 100 may be provided with a solvent used for a wet reaction. As described above, the solvent may be an aprotic solvent, and the specific type is as described above.

Meanwhile, the lithium raw material may be supplied to the reaction space of the reaction chamber along a lithium raw material supply line 10. Supply of the lithium raw material may be carried out by charging it into the reaction chamber all at once, or via a conveyor belt installed outside the reaction chamber 100 to implement an automated/semi-automated process. In addition, the lithium raw material supply line 10 may be installed vertically or inclined to allow the lithium raw material to move into the reaction chamber by gravity. In addition, a separately provided ventilation means may be used to move the lithium raw material. A stirring member 110 may be provided within the reaction chamber to promote the lithium sulfide production reaction or to crush the product. The stirring member 110 may be, for example, a rotating disk, a rotary stirrer, a propeller, or the like.

The heating portion 150 may be provided adjacent to or in contact with the reaction chamber to heat the predetermined reaction space. For example, the heating portion 150 may be a heater, electric heating wire, or infrared heater mounted on the exterior of the reaction chamber 100, and it may perform heating so that the reaction space has a temperature ranging from 120 to 300° C., specifically from 120 to 250° C., and more specifically from 120 to 200° C.

Meanwhile, for the lithium raw material and hydrogen sulfide to react smoothly, the temperature within the reaction chamber must be sufficiently elevated. As shown in <Chemical Equation 1>, water (H₂O) is produced as a byproduct of the reaction between lithium hydroxide and hydrogen sulfide, which may cause a reverse reaction of the lithium sulfide production reaction and, by being located between lithium hydroxide particles or between the particles and the solvent, reduce the area of the lithium raw material that reacts with hydrogen sulfide. Therefore, the reaction space may be heated to a temperature of 120° C. or higher to remove moisture and water vapor, thereby promoting the forward reaction and obtaining high-purity lithium sulfide. However, since lithium hydroxide, one of the lithium raw materials, has a melting point of 445° C., it is preferable that the temperature of the reaction space does not exceed 445° C. Furthermore, since an excessive increase in the reaction temperature may cause corrosion of the reaction apparatus and piping, heating must be performed within the above-described temperature range.

Meanwhile, as the temperature of the reaction space increases, there is a greater risk of corrosion of an inner surface of the reaction chamber 100 and piping due to hydrogen sulfide, so the reaction chamber 100 and piping may be manufactured of a material having high heat resistance and corrosion resistance. For example, the reaction chamber 100 may be made of one material selected from the group consisting of Hastelloy, stainless steel (SUS), alumina, quartz, and a combination thereof, specifically, one material selected from the group consisting of Hastelloy X, stainless steel 304 (SUS 304), stainless steel 310 (SUS 310), stainless steel 316 (SUS 316), alumina, quartz, and a combination thereof. When the reaction chamber and piping are made of the above-described materials and the temperature of the reaction space is maintained within the above-mentioned range, frequent repair or replacement of equipment such as the reaction chamber 100 and piping can be prevented, while sufficiently promoting the reaction between hydrogen sulfide and the lithium raw material, thereby obtaining high-purity lithium sulfide.

The hydrogen sulfide supply portion 200 is provided to supply hydrogen sulfide to the reaction chamber 100. Specifically, the hydrogen sulfide supply portion 200 may be a device for supplying hydrogen sulfide to one side or a bottom of one side of the reaction chamber. Meanwhile, a hydrogen sulfide supply line 20 connecting the hydrogen sulfide supply portion 200 and the reaction chamber 100 may be provided with a sparger or an inline-disperser (not shown) for bubbling supply of hydrogen sulfide. The sparger and inline-disperser may be devices for high-pressure mixing of supplied fluids, and these devices may be controlled to have an optimal pressure and temperature range so that hydrogen sulfide (H₂S) is supplied into the reaction chamber in a bubbled state.

Hydrogen sulfide supplied into the reaction chamber along the hydrogen sulfide supply line 20 may be sprayed downward by a spray nozzle. When hydrogen sulfide is sprayed downward, the time that hydrogen sulfide (H₂S) gas remains in the solvent increases, thereby increasing the efficiency of the lithium sulfide production reaction and reducing the proportion of unreacted hydrogen sulfide discharged outside the reaction chamber.

The condensation portion 300 may be for selectively condensing gas discharged from the reaction chamber 100 along an exhaust line 30, and it may be provided with a separate cooling means (not shown) for this purpose. For example, the condensation portion may be a condenser utilizing a heat exchange method. For example, when the temperature of the condensation portion is set to be less than 100° C., specifically less than 70° C., and more specifically less than 50° C., the water vapor and solvent discharged from the reaction chamber are liquefied, but unreacted hydrogen sulfide passes through the condensation portion in a gaseous state.

The hydrogen sulfide re-supply portion 400 may be a device for recovering unreacted hydrogen sulfide (H₂S) that has passed through the condensation portion and supplying the recovered unreacted hydrogen sulfide to the reaction chamber 100 along the hydrogen sulfide re-supply line 40. In addition, the hydrogen sulfide re-supply portion 400 may include a moisture removal portion (not shown). Specifically, the unreacted hydrogen sulfide (H₂S) recovered from the condensation portion may be supplied back to the reaction chamber 100 with moisture completely removed while passing through the hydrogen sulfide re-supply portion, and when the unreacted hydrogen sulfide is recovered and re-supplied in this manner, the economic efficiency of the process is improved. Meanwhile, the moisture removal portion is not particularly limited as long as it is capable of removing moisture/water vapor from the recovered unreacted hydrogen sulfide gas. For example, it may be a device configured to selectively liquefy and remove only water vapor by pressurizing gas under high pressure conditions. In this case, unlike a method of removing moisture through cooling, a separate heating process is not required before supplying the recovered unreacted hydrogen sulfide gas to the reaction chamber, which may be advantageous in terms of process economy and efficiency.

The hydrogen sulfide re-supply line 40 may be directly connected to the reaction chamber 100 or may be connected to the hydrogen sulfide supply line 20. When the hydrogen sulfide re-supply line 40 is directly connected to the reaction chamber, the hydrogen sulfide re-supply line 40 may be provided with a sparger or an inline-disperser (not shown) for bubbling supply of hydrogen sulfide, similar to the above-described hydrogen sulfide supply line 20.

The solvent re-supply portion 500 is a device component that receives a mixture of the solvent and water liquefied from the condensation portion 300, separates them based on the difference in boiling point or specific gravity, and then selectively recovers only the solvent. The solvent recovered from the solvent re-supply portion 500 may be supplied back into the reaction chamber 100 along a solvent re-supply line 50. Meanwhile, one or more solvent re-supply portions may be provided, and when there are two or more solvent re-supply portions, they may be provided in a series or parallel form as needed. The solvent re-supply portion 500 may be a Dean-Stark trap or an oil-water separator. Meanwhile, the water separated in the above-described process is removed along a water discharge line WD.

The lithium sulfide recovery portion 600 is a component to which a product generated in the reaction chamber 100 is delivered, and the product may be delivered along the lithium sulfide recovery line 60. In the lithium sulfide recovery portion, a process for removing solvents and impurities and drying may be carried out before obtaining the final lithium sulfide. Meanwhile, the lithium sulfide recovery portion is not particularly limited, but it may be a chamber having a shape such as a cylinder, a square, a rectangle, a cone, an inverted cone. For example, the lithium sulfide recovery portion may include a filter reactor including one or more selected from a blower, an impeller, and a filter member (F), or a vacuum filter capable of performing vacuum drying.

The blower may be a device provided at a side end or top of the lithium sulfide recovery portion to generate a gas flow in a horizontal or vertical direction. The gas flow generated by the blower removes the solvent and impurities remaining on the surface of the lithium sulfide product by moving them toward the filter member. The gas supplied from the blower may be an inert gas, as described above.

The impeller may be provided to be capable of moving up/down/left/right within the lithium sulfide recovery portion and may have one or more shapes selected from a paddle, a propeller, and a turbine. Meanwhile, the impeller may be a component that operates during the removal of impurities and drying of the product delivered to the lithium sulfide recovery portion to promote this process.

The filter member (F) may be a component that discharges the solvent and impurities separated from lithium sulfide to the outside as described above and may be made of one material selected from Hastelloy, stainless steel (SUS), and a combination thereof, specifically, one material selected from Hastelloy X, stainless steel 304 (SUS 304), stainless steel 310 (SUS 310), stainless steel 316 (SUS 316), and a combination thereof. In addition, the filter member (F) may be a mesh filter that sieves particles having a particle size of 1 μm or more.

The inert gas supply portion 700 is a component for supplying an inert gas into the reaction chamber by bubbling it, and for example, the inert gas may be supplied along an inert gas supply line 70 connected to a bottom of the reaction chamber. The inert gas may be one selected from nitrogen (N₂), argon (Ar), helium (He), and a combination thereof. Meanwhile, the inert gas supply portion or the inert gas supply line may be provided with a sparger or an inline-disperser (not shown) for bubbling supply. Meanwhile, the flow of the inert gas supplied by bubbling may be controlled to have a flow rate in a range of 1 to 10 kph.

### EXAMPLES

The present invention is susceptible to various modifications and takes various forms. Specific embodiments are illustrated and described in detail below. However, this is not intended to limit the present invention to any specific disclosed form, but should be understood as encompassing all modifications, equivalents, and alternatives falling within the spirit and technical scope of the present invention.

### Example 1-1

A cylindrical reaction chamber (100 L) was prepared, and 28 kg (0.25 kmol) of an octane mixture as a solvent was introduced into the chamber. Thereafter, 20 kg (0.48 kmol) of lithium hydroxide monohydrate (LiOH·H₂O) was introduced into the chamber. Nitrogen (N₂) was introduced as an inert gas at a rate of 0.2 kph using a lower sparger, and the mixture was refluxed and stirred for two hours. 8.6 kg of water produced during this process was recovered/removed using an oil-water separator (corresponding to Step a)).

Next, hydrogen sulfide (H₂S) was introduced into the reaction chamber at a rate of 1.5 kph. The internal pressure was maintained at 2 bar and the temperature at 150° C., and the mixture was refluxed and stirred for 20 hours. 8.25 kg of water produced at this time was recovered using an oil-water separator. After chemical equilibrium was reached so that no lithium sulfide was further produced, the introduction of hydrogen sulfide was stopped, the pressure in the reaction chamber was reduced to 0.01 bar, and nitrogen (N₂) was bubbled through the bottom sparger at a rate of 1 kph while refluxing and stirring for one hour. Next, the introduction of nitrogen was stopped, and hydrogen sulfide (H₂S) was injected again at a rate of 1.5 kph. While maintaining the internal pressure of the reaction chamber at 2 bar and the temperature at 150° C., the mixture was refluxed and stirred for one hour (corresponding to Step b)).

After the lithium sulfide production reaction was completed, the reaction chamber temperature was lowered to 80° C., filtration was performed using a Nutsche filter, and the product was dried under reduced pressure at 80° C. in a glove box to obtain 9.71 kg (0.21 kmol) of lithium sulfide as a white solid (corresponding to Step c)).

### Example 1-2

The same procedure as Example 1-1 was performed, except that in Step b), the nitrogen (N₂) bubbling and hydrogen sulfide (H₂S) re-supply process was repeated twice.

### Example 1-3

The same procedure as Example 1-1 was performed, except that in Step b), the nitrogen (N₂) bubbling and hydrogen sulfide (H₂S) re-supply process was repeated three times.

### Comparative Example 1

The same procedure as Example 1-1 was performed, except that in Step b), the nitrogen (N₂) bubbling and hydrogen sulfide (H₂S) re-supply process was omitted.

### Experiment. Experiments for Measuring Physical Properties of Lithium Sulfide

### X-Ray Diffraction (XRD) Measurement Experiment

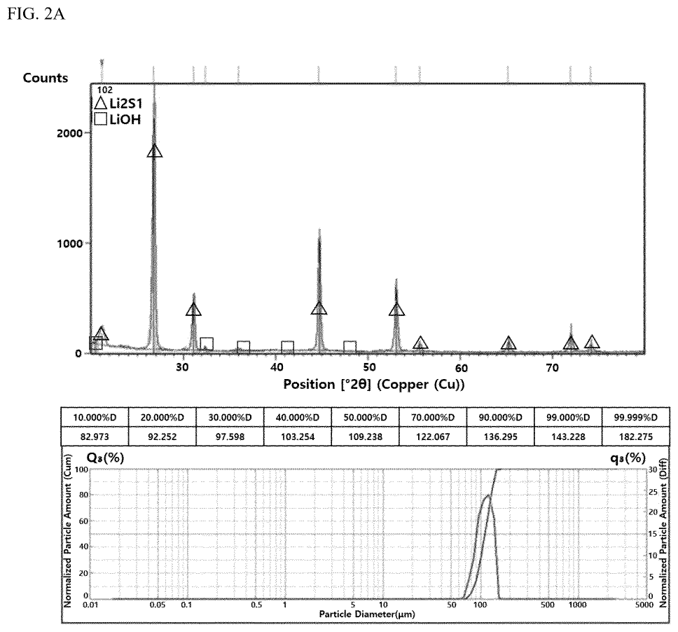

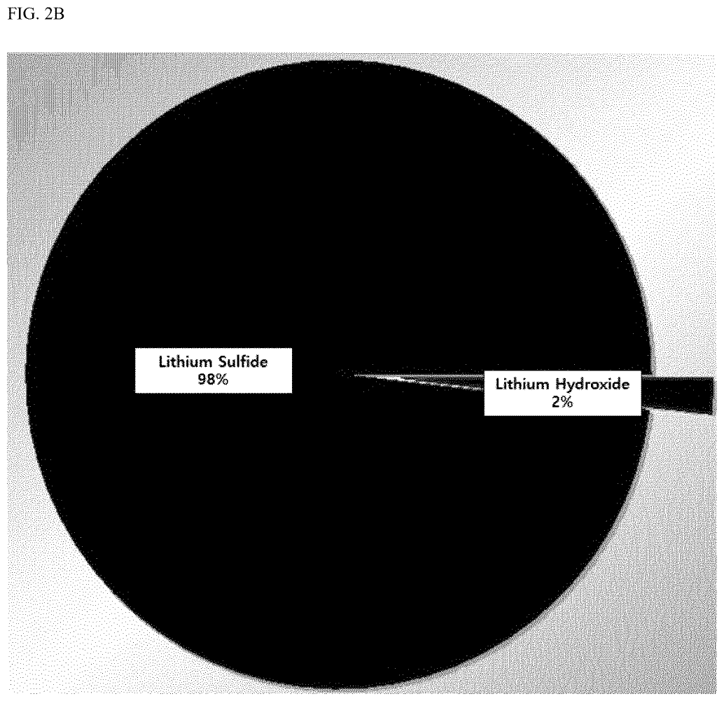

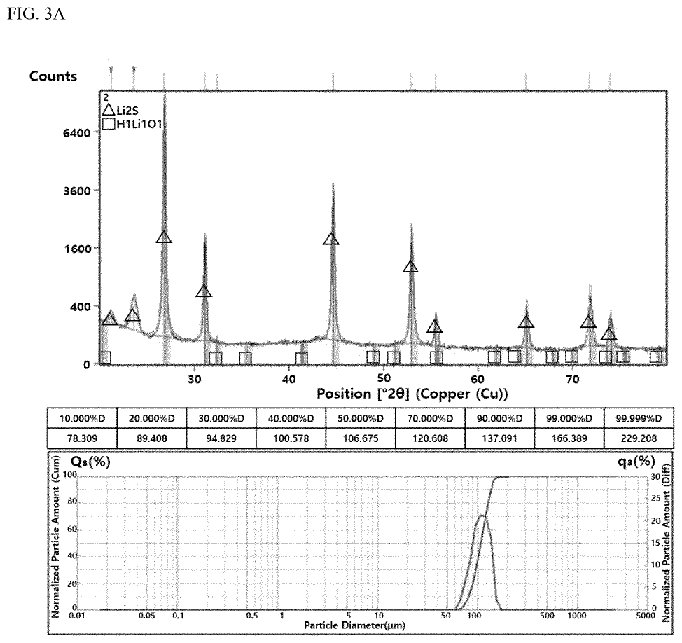

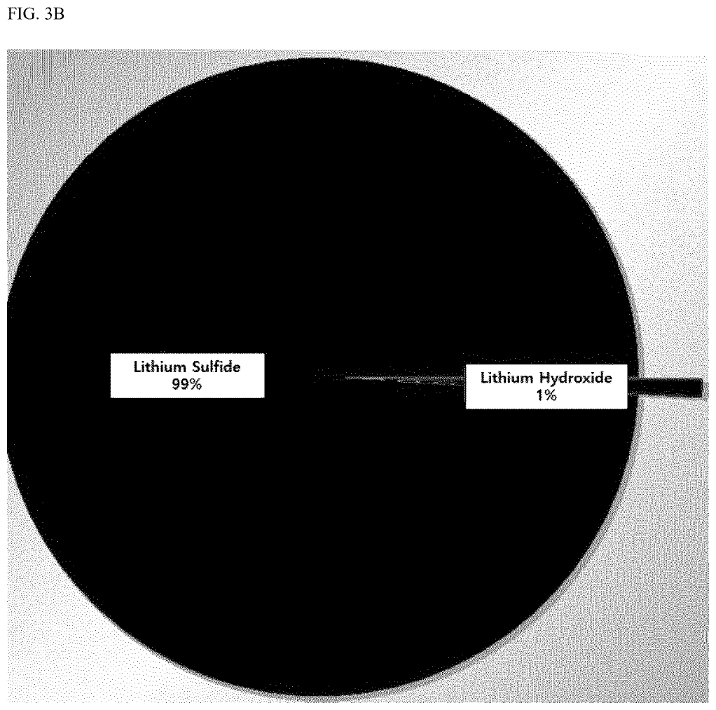

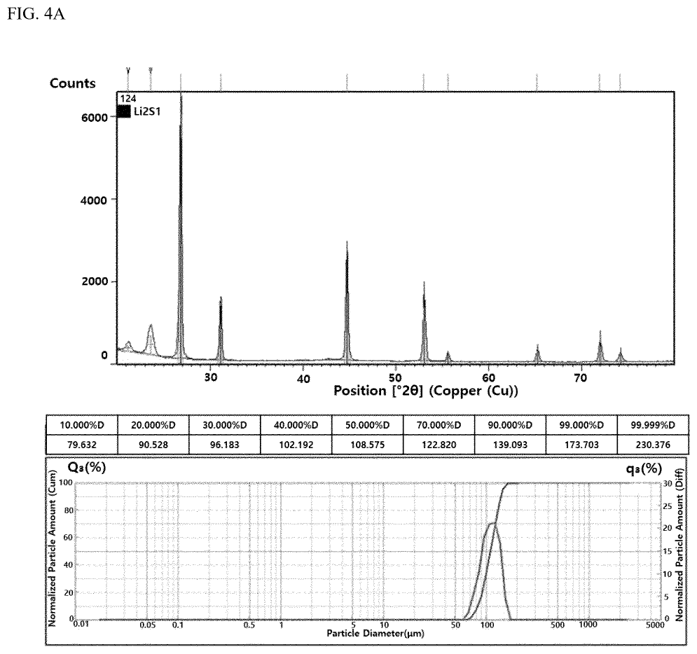

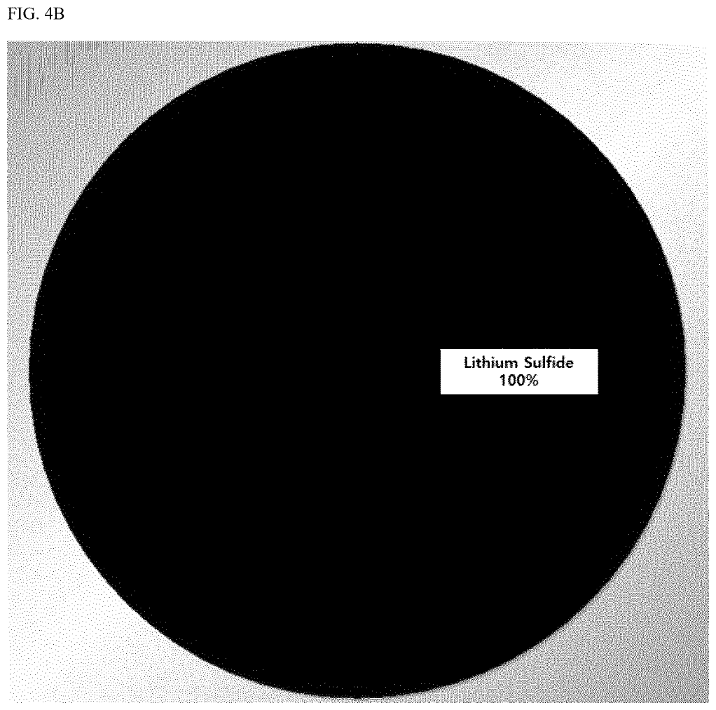

Lithium sulfide (Li₂S) recovered according to the examples and the comparative example was prepared, and XRD measurements using CuKα radiation were performed. The peak corresponding to lithium sulfide at 2θ=44.6 and the peak corresponding to lithium hydroxide at 2θ=32.3 were mainly observed. As shown in FIGS. 2A and 2B, the results of the XRD semi-quantitative analysis for Example 1-1 showed a purity of 98.00%. As shown in FIGS. 3A and 3B, the results of the XRD semi-quantitative analysis for Example 1-2 showed a purity of 99.00%. As shown in FIGS. 4A and 4B, the results of the XRD semi-quantitative analysis for Example 1-3 showed a purity of 99.99%.

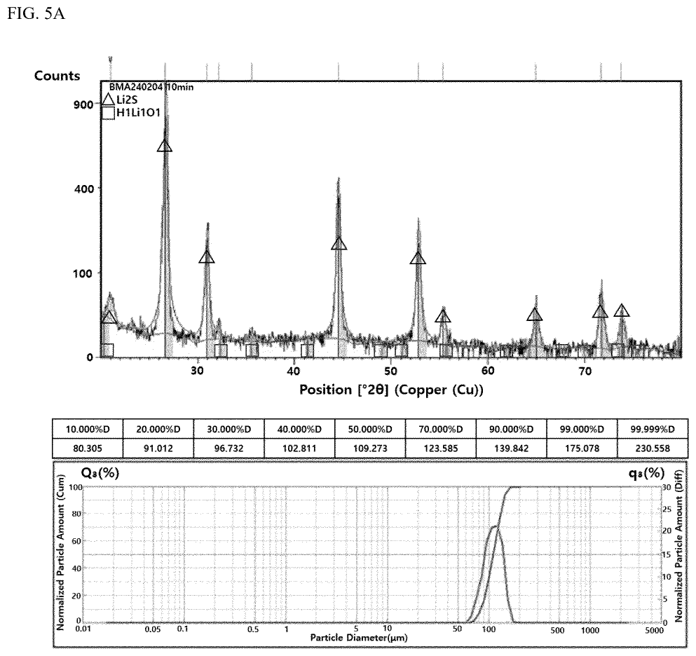

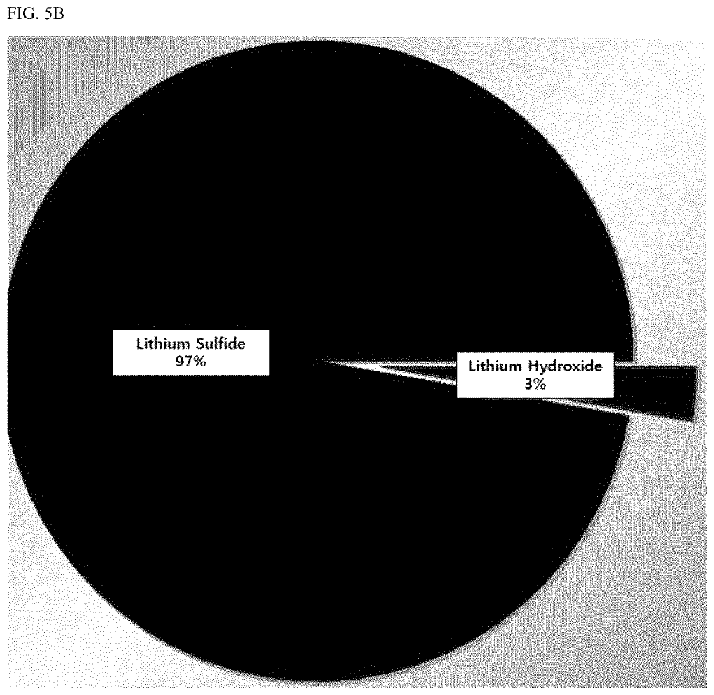

Meanwhile, as shown in FIGS. 5A and 5B, the XRD semi-quantitative analysis results for Comparative Example 1 showed 97.00% lithium sulfide and 3.00% lithium hydroxide.

### BET Specific Surface Area Measurement Experiment

Lithium sulfide (Li₂S) recovered according to the examples and the comparative example was prepared, and the specific surface area was measured using a Nova 800 using the BET method using nitrogen gas. The results confirmed that the lithium sulfide according to Example 1-1 had a specific surface area of 9.5 m²/g, the lithium sulfide according to Example 1-2 had a specific surface area of 9.7 m²/g, and the lithium sulfide according to Example 1-3 had a specific surface area of 9.3 m²/g.

Meanwhile, the results confirmed that the lithium sulfide according to Comparative Example 1 had a specific surface area of 9.3 m²/g.

### Particle Size Analysis Experiment

Lithium sulfide (Li₂S) recovered according to the examples and the comparative examples was prepared, and a particle size analysis was performed using a SALD-2300 instrument. The measurement results confirmed that the average particle size (D50) of Example 1-1 was 109.2 μm (see FIGS. 2A and 2B), that of Example 1-2 was 106.6 μm (see FIGS. 3A and 3B), and that of Example 1-3 was 108.5 μm (see FIGS. 4A and 4B).

Meanwhile, the average particle size (D50) of the lithium sulfide according to Comparative Example 1 was 109.2 μm (see FIGS. 5A and 5B).

The above-described experimental results are summarized in Table 1 below.

TABLE 1

| | Lithium sulfide purity | | |
|---|---|---|---|
| | according to XRD semi- | BET specific | average |
| | quantitative analysis | surface area | particle size |
| | results (%) | (m²/g) | (D50) (μm) |
| Example 1-1 | 98.00 | 9.5 | 109.2 |
| Example 1-2 | 99.00 | 9.7 | 106.6 |
| Example 1-3 | 99.99 | 9.3 | 108.5 |
| Comparative | 97.00 | 9.3 | 109.2 |
| Example 1 | | | |

Referring to the results in Table 1 above, it was confirmed that when the lithium sulfide production reaction reaches chemical equilibrium as in the examples of the present invention, when an inert gas is supplied by bubbling and then hydrogen sulfide is re-supplied into the reaction chamber, moisture in the reaction chamber is removed, the chemical equilibrium is broken, and the forward reaction is promoted, so the purity of the ultimately obtained lithium sulfide is significantly improved compared to the comparative example.

The above description is merely an illustrative description of the technical idea of the present invention, and those skilled in the art will understand that various modifications and changes can be made without departing from the essential features of the present invention. Therefore, the embodiments disclosed in the present invention are intended to illustrate, rather than limit, the technical idea of the present invention, and the scope of the technical idea of the present invention is not limited by these embodiments. The scope of protection of the present invention should be interpreted by the following claims, and all technical ideas within a scope equivalent thereto should be interpreted as being included in the scope of rights of the present invention.

### REFERENCE NUMERALS

10: Lithium raw material supply line
20: Hydrogen sulfide supply line
30: Exhaust line
40: Hydrogen sulfide re-supply line
50: Solvent re-supply line
60: Lithium sulfide recovery line
70: Inert gas supply line
WD: Water (H₂O) discharge line
100: Reaction chamber
110: Stirring member
150: Heating portion
200: Hydrogen sulfide supply portion
300: Condensation portion
400: Hydrogen sulfide re-supply portion
500: Solvent re-supply portion
600: Lithium sulfide recovery portion
700: Inert gas supply portion
F: Filter member

What is claimed is:

1. A method of producing lithium sulfide, comprising:
a) a step of supplying a lithium raw material into a reaction chamber provided with a solvent;
b) a step of supplying hydrogen sulfide (H₂S) into the reaction chamber to initiate a lithium sulfide (Li₂S) production reaction, the step including, when the reaction reaches chemical equilibrium, supplying an inert gas by bubbling and then re-supplying the hydrogen sulfide into the reaction chamber; and
c) a step of transferring a product obtained in Step b) to a lithium sulfide recovery portion to obtain lithium sulfide.

2. The method of claim 1, further comprising, after Step a) and before Step b), a step of removing moisture within the reaction chamber by heating for one to five hours while maintaining the reaction chamber at a temperature ranging from 80 to 200° C.

3. The method of claim 1, wherein the solvent of Step a) is an aprotic solvent selected from cycloheptane, cyclooctane, methylcyclohexane, dimethylcyclohexane, trimethylcyclohexane, ethylcyclohexane, diethylcyclohexane, propylcyclohexane, isopropylcyclohexane, dipropylcyclohexane, butylcyclohexane, tert-butylcyclohexane, methylcycloheptane, and methylcyclooctane; octane, isooctane, nonane, isononane, decane, isodecane, undecane, dodecane, hexadecane, and octadecane; toluene, o-, m-, and p-xylene, 1,3,5-trimethylbenzene (mesitylene), 1,2,4- and 1,2,3-trimethylbenzene, ethylbenzene, propylbenzene, isopropylbenzene, butylbenzene, isobutylbenzene, tert-butylbenzene, and cyclohexylbenzene; naphthalene, decahydronaphthalene (decalin), 1- and 2-methylnaphthalene, 1- and 2-ethylnaphthalene; tetrahydrofuran, 2-methyltetrahydrofuran, 2,5-dimethyltetrahydrofuran, 1,4-dioxane, dibutyl ether, isoamyl ether, dihexyl ether, 1,2-dimethoxyethane; and a combination thereof.

4. The method of claim 1, wherein the solvent of Step a) is provided in a volume ranging from 50% to 80% based on a total volume of the reaction chamber.

5. The method of claim 1, wherein the lithium raw material of Step a) is one selected from lithium hydroxide (LiOH), lithium hydroxide monohydrate (LiOH·H₂O), lithium carbonate (Li₂CO₃), and a combination thereof.

6. The method of claim 1, wherein the lithium sulfide production reaction in Step b) is as shown in Chemical Equation 1 below and is performed for 10 to 60 hours at a temperature ranging from 120 to 300° C. and a pressure ranging from 0.01 to 5.0 bar in the reaction chamber.

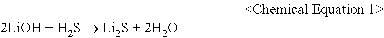

7. The method of claim 1, wherein in Step b), the inert gas is one selected from nitrogen (N₂), argon (Ar), helium (He), and a combination thereof.

8. The method of claim 1, wherein in Step b), a solvent replenished during the reaction is one selected from a newly supplied solvent, a solvent recovered between processes, and a combination thereof.

9. The method of claim 1, wherein in Step c), a gas flow is generated in the lithium sulfide recovery portion to remove the solvent and impurities and dry the lithium sulfide.

10. The method of claim 1, wherein a percentage of the lithium raw material that is consumed by the reaction through Steps a) to c) is 97.99% or more.

11. Lithium sulfide produced according to the method of claim 1, having an average particle size (D50) in a range of 1 to 200 μm and a Brunauer-Emmett-Teller (BET) specific surface area in a range of 1 to 14 m²/g.

12. The lithium sulfide of claim 11, wherein the lithium sulfide has a carbon content of less than 0.5% by weight and a purity of 97.99% or more.

13. A lithium all-solid-state secondary battery comprising: a positive electrode; a negative electrode facing the positive electrode; and a sulfide-based solid electrolyte interposed between the positive electrode and the negative electrode and made of the lithium sulfide according to claim 11.

14. The lithium all-solid-state secondary battery of claim 13, wherein the lithium all-solid-state secondary battery is applied to one or more products selected from electric vehicles (EVs), hybrid electric vehicles (HEVs), energy storage systems (ESSs), urban air mobility (UAM), mobile devices, laptops, electronic devices, tablets, drones, robots, and home appliances.
